(19) United States
(12) Patent Application Publication
(10) Pub. No.: US 2018/0194071 A1
(43) Pub. Date: Jul. 12, 2018

(54) Variable Volume Support Member for Cure of Composite Structure

(71) Applicant: Applied Composite Technology Aerospace, Inc., Fayette, UT (US)

(72) Inventor: Todd Ashton, Fort Worth, TX (US)

(73) Assignee: Applied Composite Technology Aerospace, Inc., Fayette, UT (US)

(21) Appl. No.: 15/400,639

(22) Filed: Jan. 6, 2017

(51) Int. Cl. B29C 65/02; B29C 35/02

(52) U.S. Cl. CPC B29C 65/02; B29K 2883/00; B29C 35/02

(57) ABSTRACT

Forming a cured composite structure may include assembling pre-cure members about a variable volume support member to form a pre-cure assembly, applying an internal pressure from within the pre-cure assembly by maintaining the variable volume support member at an expanded volume, and curing the pre-cure members by applying heat while the variable volume support member is in the expanded volume to form a cured composite structure.

### BACKGROUND

Composite materials having a fiber-reinforced resin matrix are often used to fabricate lightweight, high strength parts. Some of these parts may include geometries that include internal cavities, which makes the use of internal tooling problematic since the tooling can become trapped within the cavity after the pre-assembled structure is cured. Fabrication of composite parts with trapped geometries typically includes use of a solid mandrel having an exterior shape generally conforming to the desired interior shape of the part. Uncured composite materials are then laid up on the mandrel and cured by applying heat and pressure according to well-known methods. In those situations where the cured structures include an internal cavity, the internal tooling is often destroyed or taken apart in pieces to remove the tooling from the cured structure.

The internal tooling in the form of expendable mandrels are typically made of plaster, water soluble eutectic salts, or even eutectic metals. In the case of plaster, the mandrel is removed by breaking it away from the cured structure using impact devices after the composite part has been cured in an oven or autoclave. The broken plaster pieces are then discarded at a significant cost to the manufacturer. Further, the use of breakaway plaster is labor intensive, can result in irreparable damage to the cured composite parts, and produces large quantities of waste which are costly to dispose of.

The use of eutectic salts or metals may be environmentally hazardous and recovery is not cost effective in many cases due to contamination and/or degradation of the material. These materials also tend to fuse to, and often contaminate the interior surface of a structure, making it necessary to provide a reliable barrier, which also needs to be subsequently removed. These mandrels are heavy and fragile, particularly those made with eutectic metals.

One example of removing a mandrel from a cured composite structure is disclosed in U.S. Pat. No. 6,589,472 issued to Ross A. Benson. In this reference, a thermoplastic conformal tool/vacuum bag that is structured to substantially conform to a surface or a cavity in a composite structure is placed proximate to a uncured composite member to fabricate a composite structure. External heat and external pressure are applied to cure the member. After curing, the conformal thermoplastic tool/vacuum bag can only be removed from the cured assembly by reheating or cut out with hand held routers, to facilitate removal of the tool/vacuum bag. U.S. Pat. No. 6,589,472 is incorporated herein by reference for all that it discloses. This bagging method also requires disposal of the vacuum bag, as it is only suitable for one time use.

### SUMMARY

In one embodiment of the present system and method, a method of forming a cured composite structure includes assembling pre-cure members about a variable volume support member to form a pre-cure assembly, applying an internal pressure from within the pre-cure assembly by maintaining the variable volume support member at an expanded volume, and co-bonding the pre-cure members by applying heat while the variable volume support member is in the expanded volume to form a cured composite structure.

The method may also include reducing the internal pressure and collapsing, at least in part, the variable volume support member.

The method may also include removing the variable volume support member through an opening in the cured structure in an at least partially collapsed state after collapsing the variable volume support member.

Removing the variable volume member can occur at a temperature equal to or lower than melting temperature of the variable volume member.

Reducing the internal pressure of the variable volume member may occur at atmospheric pressure.

Removing the variable volume member may occur within a temperature range of 12° Celsius to 32° Celsius.

The variable volume member may include a valve and or seal plate integrated into a wall of the variable volume member.

Reducing the internal pressure by collapsing, at least in part, the variable volume support member may include releasing a pressurization medium through the valve.

The variable volume support member may be reusable to manufacture additional cured structures.

The variable volume support member may include silicone rubber.

The method may also include taping the outer surface of the variable volume support member to prevent silicone rubber of the variable volume member from contaminating the cured structure during curing.

The variable volume member may include a range of wall thicknesses of approximately 0.06 Inches to 0.20 inches.

The cured structure may include at least a portion that has a cross section resembling an “I” shape.

At least one of the pre-cure members may be made of a woven material.

In one example, a variable volume support member includes a plurality of pliable walls fused together to define an annulus, a first end wall fused to the plurality of pliable walls that closes off the annulus at a first end, a second end wall fused to the plurality of pliable walls that closes off the annulus at a second end, and an internal cavity defined by the plurality of the pliable members. The plurality of walls and the first end wall are shaped and cured together against a removable mandrel. The second end wall is flow molded to the plurality of walls after the mandrel is removed to form the variable volume support member, and the internal cavity is air tight.

The plurality of walls, the first end wall, and the second end wall may be made, at least in part, of silicone rubber.

The variable volume support member may include a seal plate and/or valve integrated into at least one of the plurality of walls, the first end wall, and the second end wall.

The variable volume support member may include a congruent pair of the plurality of pliable walls that are transversely oriented.

The plurality of walls, the first end wall, and the second end wall may be made, at least in part, of a thermoplastic elastomer.

In one embodiment, a pre-cure assembly includes a first pre-cure member, a second pre-cure member transversely oriented to the first pre-cure member, a joint member joining the first pre-cure member to the second pre-cure member forming a joint, a recess collectively defined by the first pre-cure member, the joint member, and the second pre-cure member, and a variable volume support member situated within the recess. The variable volume support member includes a plurality of pliable walls fused together to define an annulus, a first end wall fused to the plurality of pliable walls that closes off the annulus at a first end, a second end wall fused to the plurality of pliable walls that closes off the annulus at a second end, an internal cavity defined by the plurality of the pliable members, and a seal plate and/or valve integrated into a wall of the variable volume member. The internal cavity is air tight.

### BRIEF DESCRIPTION OF THE DRAWINGS

The accompanying drawings illustrate various embodiments of the present apparatus and are a part of the specification. The illustrated embodiments are merely examples of the present apparatus and do not limit the scope thereof.

FIG. 1 depicts an exploded view of an example of a pre-cure assembly in accordance with the present disclosure.

FIG. 2 depicts a perspective view of an example assembled pre-cure assembly in accordance with the present disclosure.

FIG. 3 depicts a perspective view of an example pre-cure assembly in accordance with the present disclosure.

FIG. 4 depicts a partially exploded view of an example of a pre-cure assembly in accordance with the present disclosure.

FIG. 5 depicts a perspective view of an example of a variable volume support member in accordance with the present disclosure.

FIG. 6 depicts a perspective view of an example pre-cure assembly in accordance with the present disclosure.

FIG. 7 depicts an exploded view of an example of a pre-cure assembly in accordance with the present disclosure.

FIG. 8 depicts a perspective view of an example of a pre-cure assembly in accordance with the present disclosure.

FIG. 9 depicts a perspective view of an example of a pre-cure assembly in accordance with the present disclosure.

FIG. 10 depicts a perspective view of an example of a cured structure in accordance with the present disclosure.

FIG. 11 is a flowchart illustrating a forming method using the variable volume support member in accordance with one embodiment of the present disclosure.

FIG. 12 illustrates steps for forming a variable volume support member in accordance with one embodiment of the present disclosure.

FIG. 13 is a cross-sectional view illustrating final steps for the forming of a variable volume support member in accordance with one embodiment of the present disclosure.

Throughout the drawings, identical reference numbers designate similar, but not necessarily identical, elements.

### DETAILED DESCRIPTION

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Additionally, for purposes of this disclosure, the term “width” means the dimension of an object from side to side. Often, the width of an object is transverse the object's length.

According to the principles described in the present disclosure, a method of fabricating a cured structure is provided that uses an elastomer to create a variable volume support member or mandrel that can be used internally within a pre-assembled structure during the curing process. The variable volume support member includes an air tight internal chamber. The pressure within the internal chamber can be adjusted through a valve incorporated into a wall of the variable volume support member.

The external surface of the variable volume support member may be constructed to conform to or fit closely to internal surfaces or cavities, including wall surface variations, of a pre-cure assembly. The cavities may include dimensions that would otherwise trap conventional support members within the cavities after the curing process. According to one exemplary embodiment, the variable volume support member can be positioned and selectively inflated through a valve to a desired pressure to provide structural support for a curable assembly, and then deflated by releasing internal pressure through the valve after curing. This decreased pressure can reduce the size and/or stiffness of the variable volume support member, allowing the variable volume support member to be removed from openings in the cured structure where openings are smaller than the dimensions of the formed cavity. Additionally, the variable volume support member can be inserted into small orifices and expanded to fill the internal volume of cavities that may not be otherwise possible with more conventional tooling. Additionally, according to one embodiment, an equilibrium pressure could exist in the variable volume support member due to sealing a vacuum bag around the assembly, and then piercing the bag at the vent port. One of the advantages of the variable volume support member is that the variable volume support member can be removed at atmospheric pressure and at room temperature, which generally ranges from 12 degrees Celsius to 32 degrees Celsius. More conventional tooling often involves softening the support member on the inside of the cured structure by increasing the temperature. Not only does increasing the temperature expend energy resources and prolong the fabrication process, but unnecessarily varying the temperature of a newly formed cured structure, even though the elevated temperature for softening the internal member is below curing temperature, may affect the bonds of the newly cured composite structure. In some cases, removal of conventional thermoplastic tooling at elevated temperature can be hazardous to personnel, since melted tooling has to then be removed.

In some examples, a method of fabricating a cured structure with a variable volume support member includes assembling the pre-cure members into a pre-cure assembly while placing one or more variable volume support members into the appropriate cavities and/or recesses of the pre-cure assembly, inflating the variable volume support member to a desired pressure, vacuum bagging the entire assembly, applying external heat, atmosphere, and/or pressure to the assembly for a sufficient amount of time to cure the members of the pre-cure assembly, and removing the variable volume support member from the resulting cured structure. The cured structure may be used for the formation of any number of structures including, but not limited to, aircraft parts, I-beams, building components, automobiles, ships, construction equipment, aerospace craft, satellites, rockets, bicycles, other structures, or combinations thereof.

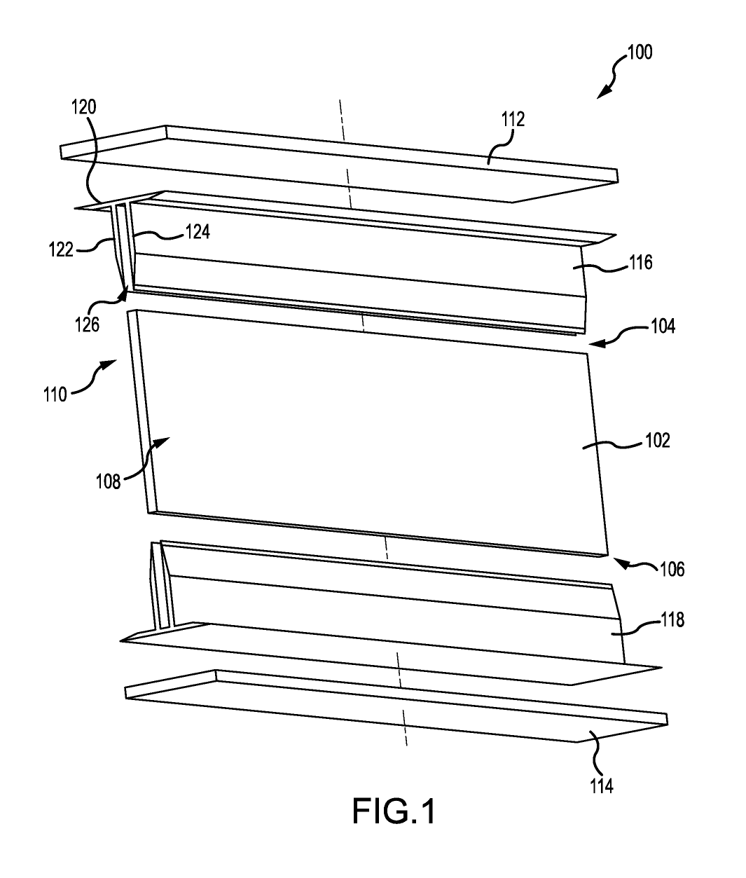

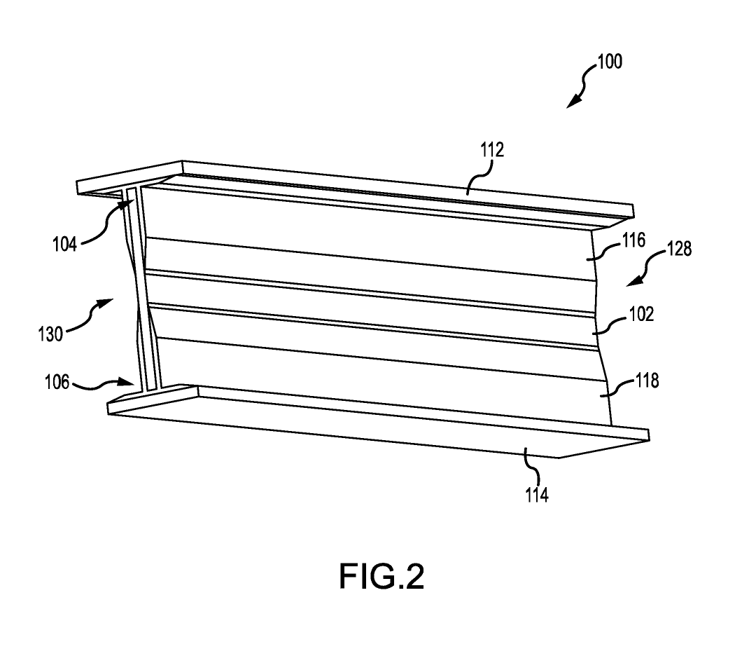

FIGS. 1 and 2 depict an example of a pre-cure assembly 100. FIG. 1 depicts an example of the pre-cure assembly 100 in an exploded view, and FIG. 2 depicts an example of the pre-cure assembly 100 with the pre-cure members assembled together. In this example, the pre-cure assembly 100 includes a plurality of pre-cure members. At least some of the pre-cure members are made of a woven structural material (such as glass or carbon based fibers) that is impregnated with a resin matrix. The plurality of pre-cure members includes a webbing 102. The webbing includes a first end 104 and a second end 106 spaced apart from the first end 104. The perimeter of the webbing 102 defines a first face 108 and a second face 110 separated by a thickness of the webbing 102. The pre-cure members include a first composite skin member 112 and a second composite skin member 114.

The first composite skin member 112 and second composite skin member 114 are transversely oriented with respect to the webbing 102. The first composite skin member 112 is positioned adjacent the webbing's first end 104, and the second composite skin member 114 is positioned adjacent to the webbing's second end 106.

A first composite joint member 116 is between the webbing's first end 104 and the first composite skin member 112. A second composite joint member 118 is between the webbing's second end 106 and the second composite skin member 114. Each of the first composite joint member 116 and the second composite joint member 118 include a flange 120 adjacent their respective skins. A first leg 122 and a second leg 124 protrude from the flange 120. The first leg 122 and the second leg 124 are spaced apart one from another and define a channel 126 that corresponds to the thickness of the webbing 102. The first end 104 of the webbing 102 and the second end 106 of the webbing 102 are inserted into the channels 126 of the first and second joint members 116, 118 respectively.

The first composite skin member 112, the first composite joint member 116, the webbing 102, the second composite joint member 118, and the second composite skin member 114 collectively form a first recess 128 and a second recess 130. The first recess 128 and the second recess 130 are opposite each other and are separated by the thickness of the webbing 102 and the joint members 116, 118. In the illustrated example, the pre-cure assembly has an “I” shape (commonly known as an “I” shape for use in I beams).

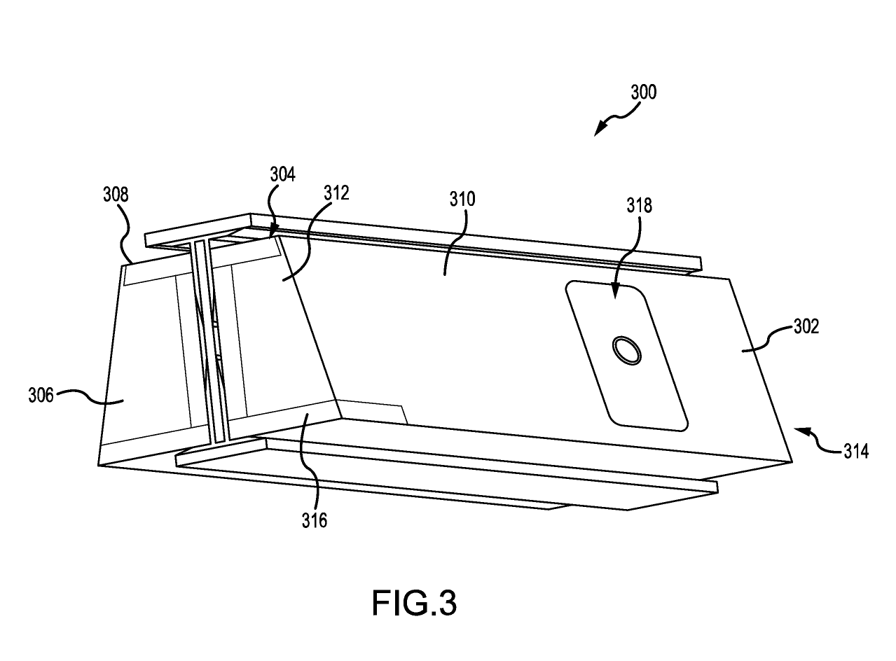

FIG. 3 depicts an example of a pre-cure assembly 300 with a first variable volume support member 302 inserted into a first recess 304 of the pre-cure assembly 300 and a second variable volume support member 306 inserted into a second recess 308 of the pre-cure assembly 300. Each of the variable volume support members 302, 306 includes a plurality of pliable walls 310 that collectively define an outer surface. The outer surface is closed to define a cavity with a first end wall 312 connected to the plurality of pliable walls on a first side and a second end wall 314 connected to the plurality of pliable walls on a second side. The first and second variable volume support members 302, 306 are sized to fill the volume of the first and second recesses 304, 308 respectively.

Each of the walls of the variable volume support members 302, 306 may be made of any appropriate polymeric material. According to one embodiment, the variable volume support members 302 are made of an elastomeric polymer, either thermoset or thermoplastic. Specifically, according to one exemplary embodiment, the elastomeric polymer is a thermoplastic elastomer. Thermoplastic elastomers may include copolymers or a physical mix of polymers (e.g. a plastic and a rubber) which includes materials with both thermoplastic and elastomeric properties. Thermoplastic elastomers often exhibit advantages of both rubbery materials and plastic materials. In some cases, the materials of the elastomer exhibit elastic properties that allow the variable volume support member to expand and contract.

One type of elastomer that may be compatible with the principles described in this disclosure includes silicone rubber. Other types of elastomers that may be used for the variable volume support member include, but are in no way limited to, styrenic block copolymers, thermoplastic olefins, elastomeric alloys, thermoplastic polyurethanes, thermoplastic copolyester, thermoplastic polyamides, ethylene propylene rubber, epichlorohydrin rubber, polyacrylic rubber, fluorosilicone rubber, fluoroelastomers (such as Viton®, Tecnoflon®, Fluorel®, Aflas®, or Dai-El®), perfluoroelastomers, polyether block amides, chlorosulfonated polyethylene, ethylene-vinyl acetate, other types of thermoplastic elastomers, or combinations thereof. According to one embodiment, an elastomeric polymer having an elongation of at least 100% and low shrinkage may be used. Depending on the resin system used for the composite structure, the elastomeric polymer chosen should remain stable at the curing temperature of the composite structure, which may range from room temperature to over 250° C.

In some examples, the variable volume support members 302, 306 come into contact with the pre-cure members within the first and second recesses 304, 308. When inserted into the first and second recesses 304, 308 the first and second variable volume support members 302, 306 can be expanded to apply an force internally on the pre-cure members during the curing. During curing, the pre-cure members soften, and the variable volume support members 302, 306 support the pre-cure members while in this softened condition and ensure appropriate consolidation of the composite structure when the resin is flowable.

In some examples, the materials that make up the walls of the variable volume support members 302, 306 may, depending on their material properties, leach out of the walls and into the curing members of the assembly during curing. To prevent this migration of materials into the curing members, at least some of the surfaces of the variable volume support members 302, 306 may be have a coating 316 applied. In some examples, this coating is a taped coating. The tape, or another type of barrier, may prevent the materials from leaching from the variable volume support member into the curing members. In other examples, the entire variable volume support member includes a non-leachable outer covering that prevents the migration of materials during curing.

Any appropriate type of seal plate and/or valve 318 may be incorporated into the variable volume support member. According to one exemplary embodiment, the seal plate and/or valve 318 may be co-bonded into the silicone rubber or other elastomer forming the variable volume support member. Alternatively, the seal plate and/or valve 318 may be incorporated into the variable volume support member by having a first and a second plate that sandwich or pinch the rubber between the two to prevent release of bond between the seal plate and the rubber. The back plate could have a seat protrusion or other feature that engages or knifes into the elastomer and ensures the seal is maintained after repeated use.

The plate or valve may be used to increase or decrease the pressure within the variable volume support member. In some cases, the pressure medium used to increase or decrease the pressure includes air, nitrogen, water, another liquid, another gas, another type of pressure medium, or combinations thereof. Additionally, the seal plate could be a sealed member including a threaded orifice formed therein for receiving any number of threaded mating fixtures including, but in no way limited to, a valve. The seal plate can be made of any number of rigid materials including, but in no way limited to, steel, aluminum, rigid polymers, composite members including inserts, and the like. Additionally, while the seal plate and/or valve 318 is described herein as a feature that is included in one wall of the variable volume support member, the seal plate and/or valve 318 may form be any size and could constitute the entire face of one side of the variable volume support member.

During curing, the pre-cure assembly 300 is in an autoclave, an oven, or another apparatus that increases the temperature of the environment around the pre-cure assembly 300. At these elevated temperature, the pre-cure members fuse together to from a unitary cured structure. Additionally, the curing apparatus may increase the atmospheric pressure imparted on the assembly during curing, again to improve the consolidation and formation of the composite part.

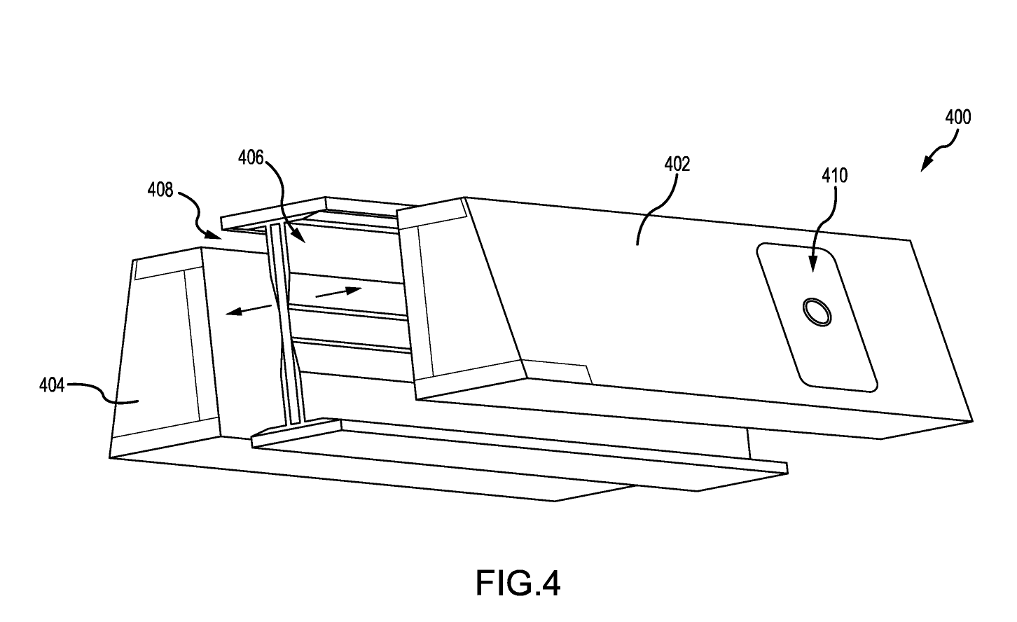

FIG. 4 depicts an example of the cured structure 400 after curing. In this example, the first and second variable volume support members 402, 404 are removed from the first and second recesses 406, 408 of the cured structure respectively. The removal of the variable volume support members 402, 404 may include decreasing the internal pressure of the variable volume support members 402, 404 by releasing the pressure medium through the seal plate and/or valve 410. The pressure may be released at room temperature and at atmospheric pressures. As the variable volume support members are deflating, its walls may pull away from the cured structure 400, and the variable volume support members 402, 404 may then be removed from the first and second recesses 406, 408. In some situations, like those depicted in FIGS. 1-4 where the opening to the first and second recesses 406, 408 are large, removal of the variable volume support members 402, 404 may involve deflating the variable volume support members 402, 404 slightly, or just enough to pull the walls away from the cured structure 400.

In the depicted examples, the variable volume support member has a substantially rectangular longitudinal cross-section. However, according to the present exemplary systems and methods, the variable volume support member may have any appropriate shape, thereby enhancing the ability to appropriately manufacture intricate closed body designs using curable composite materials.

The variable volume support member may be formed through any appropriate mechanism, including, but in no way limited to, molding, spray-molding, hand-layup, 3-D printing, etc. In some examples, the walls of the variable volume support member are formed against a form. These walls may be sprayed, coated, or otherwise applied to the form. In other examples, pre-cut wall members may be placed around the sides of the form and be supported by the form during a curing process that fuses the walls together. The partially formed variable volume support member may then be removed from the form after curing. In some examples, all but one of the walls is formed in place while the remaining wall is not formed at this time so that an internal cavity is formed in the partially finished variable volume support member. The remaining wall may be formed by positioning a pre-cut wall member over the opening and fusing the remaining wall to the plurality of walls remaining. In one example, the pre-cut wall member is heated in place on a surface. The partially formed variable volume support member is lowered downward so that the exposed edges of the walls in the opening are brought into contact with the heating pre-cut wall member. The pre-cut wall member may fuse to the rest of the variable volume support member in this condition. In another example, the variable volume support member is placed with the opening facing downward over a plate. Material for the remaining wall can be flow molded and/or extruded over the surface of the plate so that the flowing material contacts the member's wall edges and thereby fuses the remaining wall to the rest of the variable volume support member. The resulting variable volume support member may now include an air-tight cavity with the remaining co-boned wall in place.

The seal plate and/or valve that is integrally disposed in at least one wall of the variable volume support member may be a commercially available valve or a custom valve. When one of the walls of the variable volume support member is formed, the valve may be placed in any desirable location. In one example, the walls are made of a flow molded material and the valve is placed in the flow path of the moving material, which surrounds the valve. As the flowed material hardens, the valve may be bonded within the wall. The portions of the valve that are desirable to remain free of wall material may be taped to prevent the wall material from bonding to the valve in undesirable locations.

In some examples, a liner is used to surround the variable volume support members before their use as a mandrel or forming tool. The liner may include a film and a vent cloth. The film barrier may be used to facilitate removal of variable volume support member. The porous vent cloth may provide a pathway for volatile vapors and gases to escape the assembly while the members are being cured. The vent cloth may be a felt or fabric material. In other examples, the vent cloth surround the entire pre-cure assembly including the variable volume support member within the pre-cure assembly.

In some examples, at least some components of the pre-cure assembly are cured during a separate manufacturing stage before being incorporated into the pre-cure assembly. For example, the first skin and/or the second skin may be either cured or uncured in the pre-cure assembly. Having at least one of the skins already cured before assembly may provide stability and dimensional tolerances that simplify the insertion of the variable volume support member or the other components of the pre-cure assembly.

The joint members may include uncured composite whose shape resembles, but is not limited to, the Greek letter π or “pi.” The joint members may include a flange with two longitudinal legs extending therefrom. A groove or channel is defined between the two legs. The webbing may be placed into channels of the uncured composite joint member. The two legs of the uncured composite joint member may closely receive and straddle the thickness of the webbing.

Webbing may be a cured or uncured composite material. In some cases, the webbing may be made of a metal or another type of material. The joint member and the webbing may be treated with a thermoset resin, such as an epoxy, to provide a bonding medium for these materials during curing. An overwrap may be applied over joint members to improve bond strength between the joint member and the webbing. The overwrap may be an uncured laminating material such as a woven cloth or reinforcing fiber that may have laminating resin, such as epoxy, impregnated therein. The overwrap maybe placed on the joint member extending from the skin to the webbing.

After the skins, the joint members, the webbing, and the variable volume support members are assembled and sealed in an external vacuum bag, the assembly may be debulked to compact and/or reduce the volume of the pre-cure assembly. Debulking may include drawing a vacuum over the pre-cure assembly to remove air and thereby remove impurities from the pre-cure assembly's ambient environment. A vacuum fitting may pierce and seal into an appropriate portion of the external vacuum bag which envelopes the pre-cure assembly. A vacuum hose may be attached to the fitting and vacuum to draw on the entire assembly.

In some examples, the vacuum is retained when the pre-assembly is placed in an oven or autoclave and heated according to a thermal profile suitable for curing the pre-cure assembly. Structural bonds are thereby created that integrally link joint members to the webbing and skins to fabricate the desired cured structure. If desired, autoclave pressure is simultaneously applied to augment compaction of the composite while assembly is being cured. When additional heat is applied, the pressure within the variable volume support members may increase, consequently, the increase in pressure may be taken into account when providing the initial pressure to the variable volume support member.

External heat and pressure can be applied to the debulked assembly according to a temperature and pressure profile appropriate for the thermosetting resin used. In the case of epoxy laminating resins that are used in most aerospace applications, the temperature for curing is generally about 350° F. The external pressure applied can range from atmospheric (14 psig) to 200 psig, however 90 to 100 psig is more commonly used. The curing process may create structural bonds that integrally link the joint members to the webbing members and skin.

Following completion of the desired cure cycle, the external vacuum bag and tooling, if any, are removed, yielding a completed cured structure. The assembly does not have to be re-heated to remove the variable volume support member. Rather, the variable volume support member is deflated allowing the variable volume support member to be smaller than the orifice created in the cured structure for removal. One advantage of merely deflating the variable volume support member rather than softening the variable volume support member for removal is that the variable volume support member can be reused multiple times.

Additionally, the variable volume support member can be collapsed and reintroduced to the cavity of a co-bonded structure multiple times during a manufacturing process for subsequent processing. By way of example, after a desired shape is cured, the variable volume support member can be removed for processing, and then reintroduced into a cavity to provide additional structure to the formed shape if desired for a subsequent machining, finishing, or bonding step.

The present exemplary fabrication method may reduce tooling and production costs, while improving reliability. According to this exemplary method, pressure distribution provided with the variable volume support member is improved and bridging is significantly reduced or eliminated during curing. Additionally, this method allows for greatly simplified removal of the variable volume support member regardless of the cure structure's geometry. Furthermore, the use of an elastomer to form the variable volume support member provides for the formation of complex features that could not be formed with traditional methods. By way of example, often features may be formed internal to a co-bonded structure, such as to add stiffness or to facilitate the mounting of additional components. For example, blades, “J” shaped stringers, “Z” shaped stringers, combinations thereof, and the like may be formed in an internal cavity of a co-bonded structure. Traditionally, such complex features had to be formed in various steps after the curing of the main outer structure. However, the flexible variable volume support member may be formed to accommodate the internal features. Since the variable volume support member is flexible when the internal pressure is reduced, the variable volume support member can accommodate and support any number of shapes having negative or otherwise varying draft angles during cure, while flexing and facilitating removal of the variable volume support member after cure.

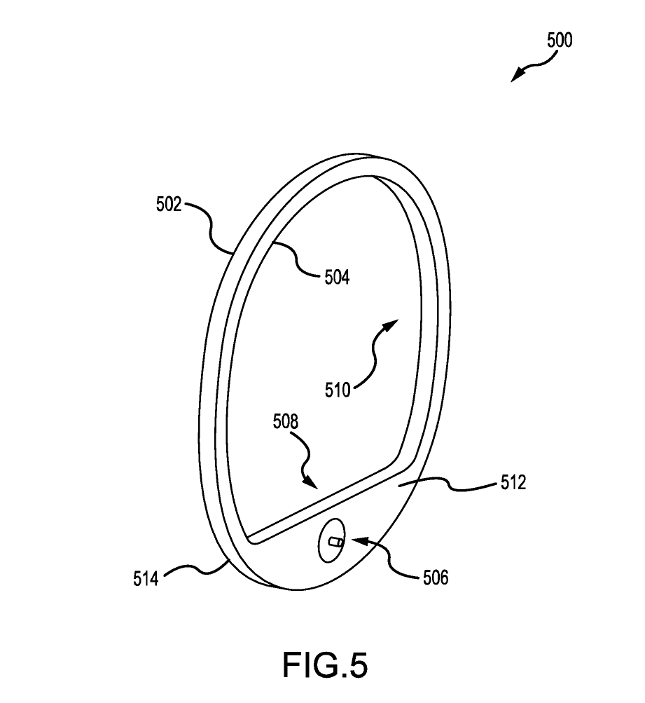

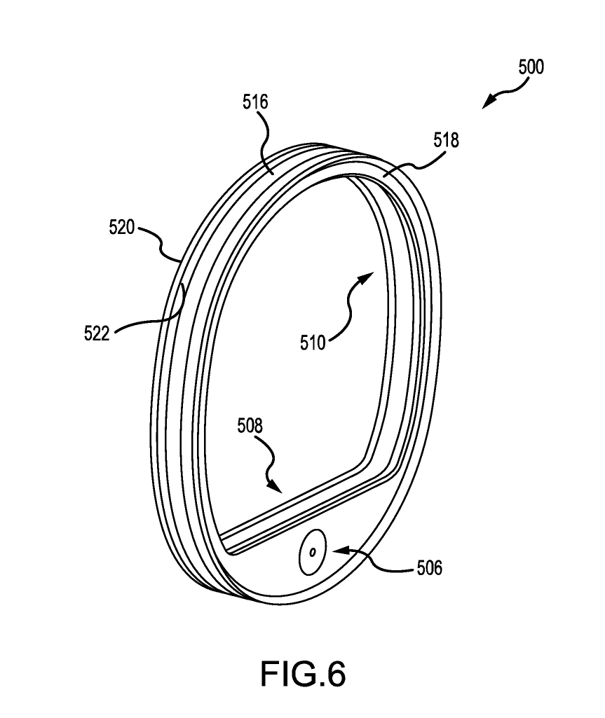

FIGS. 5 and 6 depict an example of an alternative variable volume support member 500. In this example, the variable volume support member 500 includes an outer perimeter 502 and an inner perimeter 504. In some portions of the variable volume support member 500, the distance between the outer perimeter 502 and the inner perimeter 504 vary. For example, in the region of the variable volume support member where the valve 506 is located, the distance between the outer perimeter 502 and the inner perimeter 504 is greater.

In some cases, the outer perimeter 502 is circular, ovular, rectangular, triangular, another shape, or combinations thereof. In some cases, the outer perimeter 502 has a similar shape to the inner perimeter 504. In the depicted example, however, the inner perimeter 504 has a different shape than the outer perimeter 502. The inner perimeter 504 includes a flattened section 508 and a curved section 510. While the outer perimeter 502 just contains curved sections. A first face 512 may be formed by the distance between the outer and inner perimeters 502, 504. A second face 514 may be opposite the first face and also be formed by the distance between the outer and inner perimeters 502, 504. The first face and the second face may be separated by a thickness of the variable volume support member 500.

Webbing 516 may be positioned against the outer perimeter 502 and/or the inner perimeter 504. A first skin 518 may be placed adjacent the first face 512, and a second skin 520 may be placed adjacent to the second face 514. The skins and webbing may be transversely oriented with respect to each other. Joint members 522 may connect the webbing 516 and the skins 518, 520. During a curing process, the resin matrix in the joint members, skins, and/or the webbing may harden forming a cured structure. The variable volume support member may be removed after curing. In some cases, the several of the depicted variable volume support members 500 as depicted in FIG. 5 may be placed into multiple recesses of a pre-cure assembly.

In some examples, the outer perimeter 502 may be used to shape a first pre-cure assembly while the inner perimeter 504 is used to shape a second pre-cure assembly that is independent of the first pre-cure assembly. In other examples, a first pre-cure assembly may be connected to the first face 512, while a second pre-cure assembly may be connected to the second face 514 where the first pre-cure assembly is independent of the second pre-cure assembly. In other examples, a single pre-cure assembly is formed with the variable volume support member.

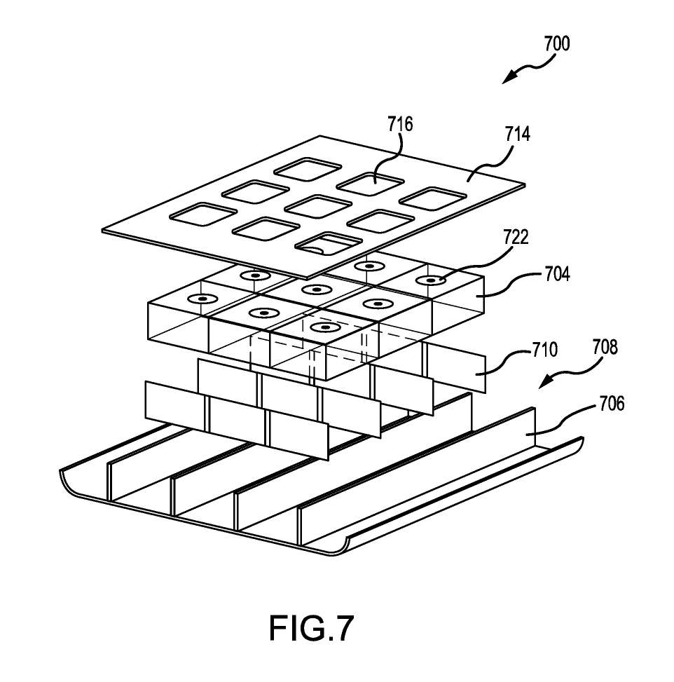

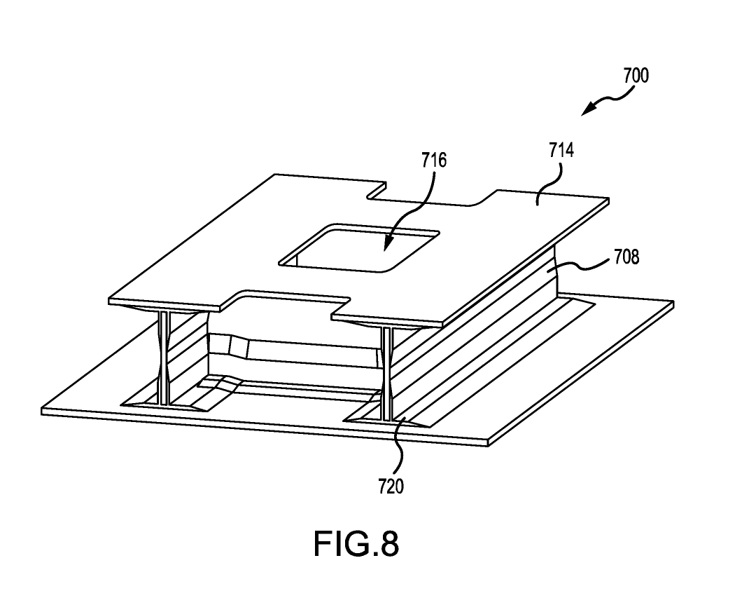

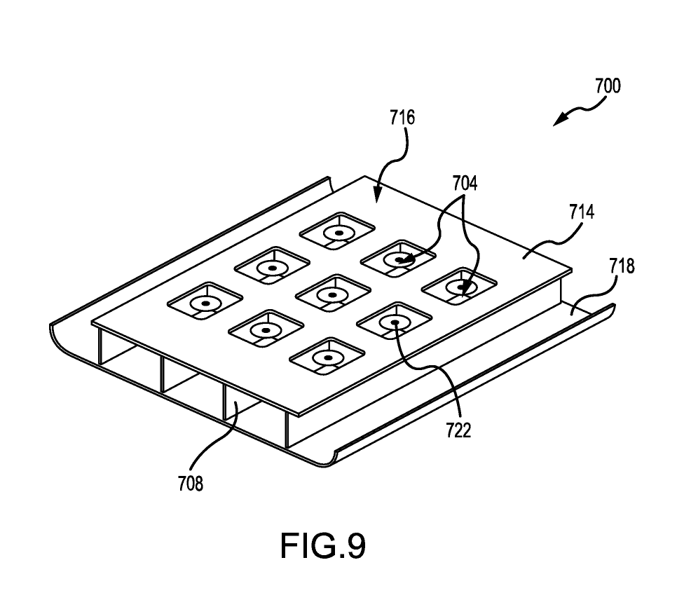

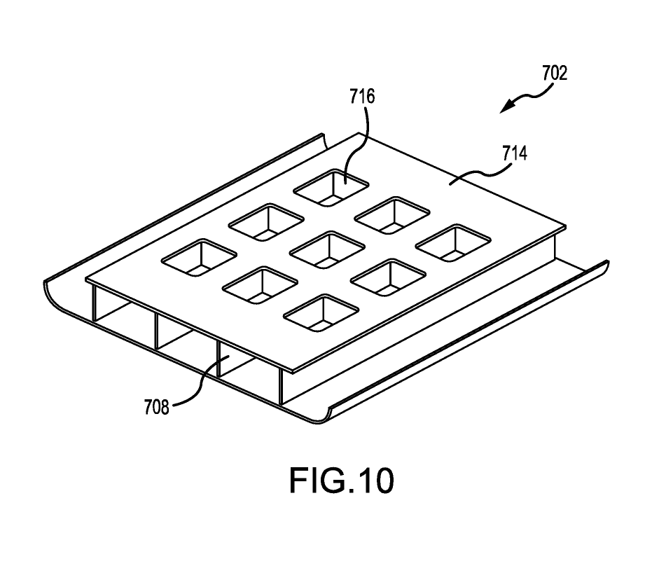

FIGS. 7-10 depict another example of using variable volume support members. FIG. 7 depicts an exploded view of portions of the pre-cure assembly 700. FIG. 8 depicts pre-cure members of the pre-cure assembly 700 assembled together with the variable volume support member removed for illustrative purposes. FIG. 9 depicts another view of the pre-cure assembly 700 with multiple variable volume support members 704 in place. FIG. 10 depicts an example of a cured structure 702 with the variable volume support members 704 removed.

The pre-cure assembly 700 includes a first set 706 of webbing 708 and a second set 710 of webbing 708 that intersects with the first set 706 and is transversely oriented with respect to the first set 706. Collectively, the first set 706 and the second set 710 of webbing 708 defines a plurality of cells 712.

A first skin 714 is positioned over the first and second sets 706, 710 of webbing 708. An opening 716 is defined in the first skin 714 for each cell 712. The variable volume support members 704 can be inserted through the openings 716 into each of the cells. In other examples, the variable volume support members 704 can be placed within each cell before positioning the first skin 714 over the webbing 708. When expanded, the variable volume support member 704 has a larger cross sectional dimension than the openings 716. Thus, in the expanded size, the variable volume support members 704 are trapped within the cells 712 due to the relatively smaller openings.

A second skin 718 is positioned underneath the first and second sets 706, 710 of webbing 708. In this example, the second skin 718 extends between the first and second sets 706, 710 of webbing 708. After curing, the extra skin material may be removed.

The first and second skins 714, 718 are connected to the webbing 708 through joint members 720. In this example, the joint members are segmented to accommodate the intersecting webbing 708.

In some cases, the variable volume support members 704 are inflated when they are initially inserted into the cells 712. In other cases, the variable volume support members 704 are expanded by adding pressure through the valve after insertion. The seal plate and/or valve 722 may be accessible through the openings 716.

After curing, each of the valves 722 may be opened to release at least some of the pressure within the variable volume support members 704. The released pressure allows the variable volume support members 704 to collapse or at least shrink in size. With the reduced size, the variable volume support members 704 can be removed from the cells 712 of the cured structure.

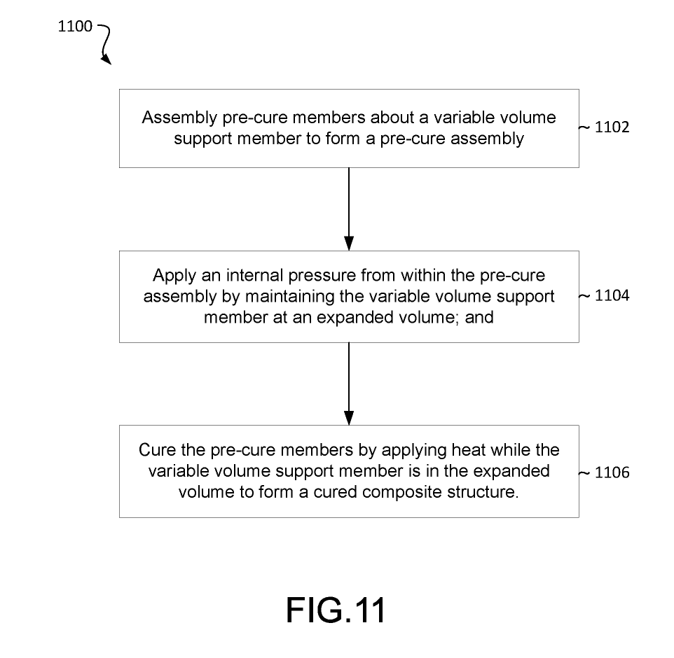

FIG. 11 depicts an example of a method 1100 for fabricating a cured structure. In this example, the cured structure includes assembling 1102 pre-cure members about a variable volume support member to form a pre-cure assembly, applying an internal pressure from within the pre-cure assembly by maintaining the variable volume support member at an expanded volume, and curing the pre-cure members by applying heat while the variable volume support member is in the expanded volume to form a cured composite structure.

At block 1102, pre-cure members are assembled about a variable volume support member. The pre-cure members may include webbing, skins, joint members, and other components of the pre-cure assembly. The variable volume support member may include a valve incorporated into at least one of its walls.

At block 1104, the internal pressure of the variable volume support member is maintained so that the variable volume support member is at an expanded volume. The internal pressure may be increased through the valve incorporated in the member's wall. In some examples, the variable volume support member is at the expanded volume when the variable volume support member is inserted into the pre-cure assembly. In other examples, the internal pressure within the variable volume support member is increased after being incorporated into the pre-cure assembly and maintained thereafter.

At block 1106, heat is applied to the pre-cure assembly while the variable volume support member is in the expanded volume while the pre-cure assembly is cured. The resulting structure, after the pre-cure assembly is cured, is a cured structure.

In some examples, the method includes removing the variable volume support member after curing. To remove the variable volume support member, the internal pressure of the variable volume support member may be decreased to reduce the variable volume support member's volume. While the variable volume support member is shrinking, the walls of the variable volume support member pull away from the cured structure. At the reduced volume, the variable volume support member can be removed from the opening.

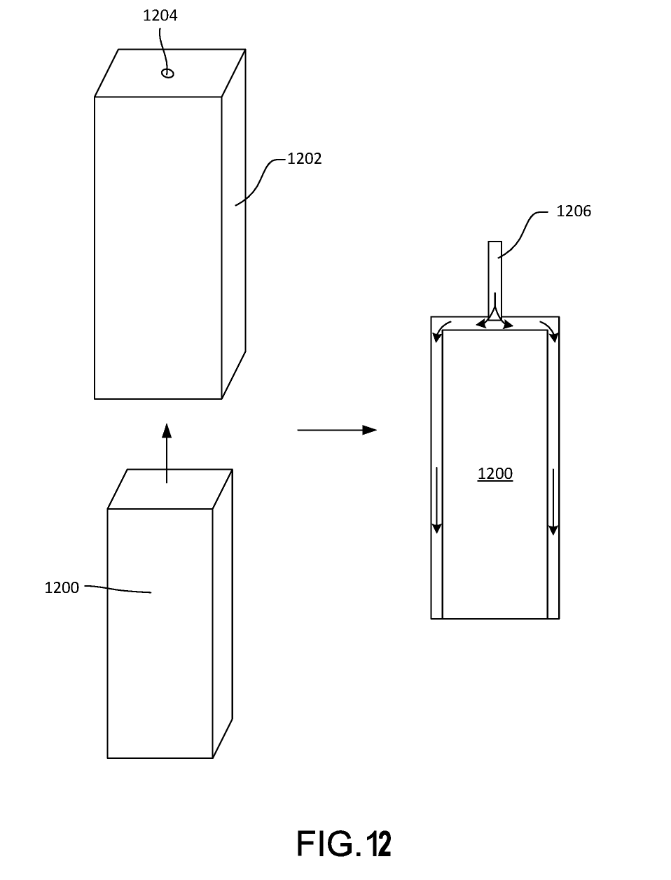

FIG. 12 depicts an exemplary method of forming a variable volume support member. In this example, a mandrel 1200 is inserted into a chamber 1202. The outside surface of the mandrel 1200 and the inside surface of the chamber 1202 are spaced apart at a distance to form a gap that corresponds with the desired wall thickness of the variable volume support member. In the illustrated example, the chamber includes an opening 1204, which provides a space for a tube 1206 to direct flow moldable material into the space between the mandrel 1200 and the chamber 1202. This flow moldable material can flow to cover five of the six sides of the mandrel 1200. The sixth side remains uncovered. After the flow moldable material is cured, the mandrel 1200 removed from the uncovered side. The mandrel 1200 may have a surface that does not adhere to the mandrel's surface easily or at all. In some examples, the cured variable volume support member is slightly melted to disengage the mandrel's surface from the cured material.

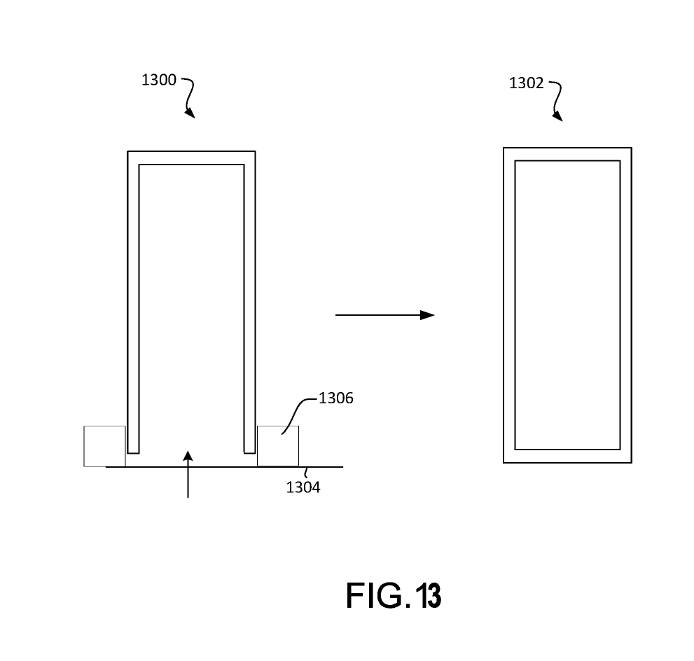

FIG. 13 depicts a cross-sectional view of an example of a partially formed variable volume support member 1300 and a fully formed variable volume support member 1302. The partially formed variable volume support member is spaced off of a curing surface 1304 at a distance that corresponds with the desired thickness of the variable volume support member's wall. The sixth side of the partially formed variable volume support member 1300 is facing the curing surface 1304.

In the illustrated example, a block 1306 is flush with at least some of the walls of the partially formed variable volume support member 1300 and flow moldable material is directed into the bottom surface of the mold and allowed to flow into the space. The blocks 1306 contain the flow moldable materials and prevent it from traveling away from the areas that are intended to be molded. In other examples, blocks 1306 are not used to contain the flow molded material. In either example, the flow moldable material is flowed underneath the partially formed variable volume support member 1300 and fills the gap. As the flow-moldable material cures it fuses to the partially formed variable volume support member 1300 and forms the fully formed variable volume support member 1302. In some examples, the partially formed variable volume support member 1300 is only partially cured and it fully cures as the flow moldable material cures completes the sixth side of the fully formed variable volume support member 1302.

While the pre-cure assemblies and cured structures above have been described with reference to specific geometries, any appropriate geometries may be used in accordance with the principles described herein. For example, in some of the examples above, the webbing and skins are flat. In alternative examples, the webbing and/or skins can be curved, rolled, wavy, zig zagged, or otherwise shaped. Also, the joint members described above have been depicted with specific shapes, but in some examples, the joint members can have different shapes than those depicted above. For example, the joint members may include a corner joint shape, a tee joint shape, a dovetail shape, a finger joint shape, a through pin joint shape, a tongue and groove shape, a rabbet shape, a lap joint shape, another type of shape, or combinations thereof.

What is claimed is:

1. A method of forming a cured composite structure, comprising:
assembling at least one pre-cure member about a variable volume support member to form a pre-cure assembly;
applying an internal pressure from within the pre-cure assembly by maintaining the variable volume support member at an expanded volume; and
curing the pre-cure members to form a cured structure.

2. The method of claim 1, further comprising reducing the internal pressure of the variable volume support member by collapsing, at least in part, the variable volume support member.

3. The method of claim 2, further comprising removing the variable volume support member in an at least partially collapsed state through an opening in the cured structure after collapsing the variable volume support member.

4. The method of claim 3, wherein removing the variable volume support member occurs at a temperature lower than a melting temperature of the variable volume support member.

5. The method of claim 3, wherein reducing the internal pressure of the variable volume support member occurs at atmospheric pressure.

6. The method of claim 3, wherein removing the variable volume support member occurs within a temperature range of 12 degrees Celsius to 32 degrees Celsius.

7. The method of claim 2, wherein the variable volume support member comprises a seal plate integrated into a wall of the variable volume support member.

8. The method of claim 7, wherein reducing the internal pressure by collapsing, at least in part, the variable volume support member includes releasing a pressurization medium through the seal plate.

9. The method of claim 1, wherein the variable volume support member is reusable to manufacture additional cured structures.

10. The method of claim 1, wherein the variable volume support member comprises a thermoset or thermoplastic elastomer.

11. The method of claim 10, wherein the thermoset elastomer comprises a silicone rubber.

12. The method of claim 10, further comprising taping an outer surface of the variable volume support member to prevent the silicone rubber of the variable volume support member from contaminating the cured structure during curing.

13. The method of claim 1, wherein the variable volume support member comprises a wall thickness of between 0.06 to 0.20 inches.

14. The method of claim 1, wherein at least one of the pre-cure members is made of a woven material.

15. A variable volume support member for the formation of a cured composite structure, comprising:
a plurality of pliable walls fused together to define an internal volume;
an end wall fused to the plurality of pliable walls, wherein the end wall closes off the internal volume; and
a seal plate or valve formed in one of the plurality of pliable walls or the end wall;
wherein the internal cavity is air tight.

16. The variable volume support member of claim 15, wherein the plurality of walls are made, at least in part, of a polymer.

17. The variable volume support member of claim 16, wherein the polymer comprises a thermoset or thermoplastic elastomer.

18. The variable volume support member of claim 17, wherein the thermoset elastomer comprises a silicone rubber.

19. The variable volume support member of claim 15, wherein a pair of the plurality of pliable walls comprise a congruent pair of pliable walls that are transversely oriented relative to one another.

20. The variable volume support member of claim 15, further comprising a barrier material coupled to at least one of the plurality of pliable walls.

21. A pre-cure assembly, comprising:
a first pre-cure member;
a second pre-cure member transversely oriented to the first pre-cure member;
a joint member joining the first pre-cure member to the second pre-cure member forming a joint;
a recess collectively defined by the first pre-cure member, the joint member, and the second pre-cure member;
a variable volume support member disposed within the recess, the variable volume support member including:
a plurality of pliable walls fused together to define an annulus;
a first end wall fused to the plurality of pliable walls that closes off the annulus at a first end;
a second end wall fused to the plurality of pliable walls that closes off the annulus at a second end;
an internal cavity defined by the plurality of the pliable members; and
a seal plate or valve integrated into a wall of the variable volume support member;
wherein the internal cavity is air tight.
